(19) United States
(12) Patent Application Publication
(10) Pub. No.: US 2016/0034718 A1
(43) Pub. Date: Feb. 4, 2016

(54) METHOD AND APPARATUS FOR COMMUNICATING PRIVATE MESSAGES WITH PARTIALLY OBSCURED CONTENT TO LIMIT OR PREVENT UNAUTHORIZED USE OF DATA TO IMPEDE PRIVACY VIOLATIONS

(71) Applicant: Criptext, Inc., New York, NY (US)

(72) Inventors: Mayer MIZRACHI, New York, NY (US); Luis LOAIZA, New York, NY (US)

(21) Appl. No.: 14/882,108

(22) Filed: Oct. 13, 2015

Related U.S. Application Data
(63) Continuation-in-part of application No. 14/044,833, filed on Oct. 2, 2013.

(51) Int. Cl. G06F 21/62; H04L 12/58

(52) U.S. Cl. CPC G06F 21/6263; H04L 51/12

(57) ABSTRACT

Some embodiments described herein relate to receiving a content portion of a message during a first time period. The content portion of the message can be presented during the first time period without a sender identifier. During a second time period after the first time period, a user can request the sender identifier. The sender identifier can be presented during the second time period without presenting the content portion of the message. In this way, the sender identifier and the content portion of the message may not be presented simultaneously.

### CROSS-REFERENCE TO RELATED APPLICATIONS

This application is a continuation-in-part of U.S. patent application Ser. No. 14/044,833, filed Oct. 2, 2013, entitled “Method and Apparatus for Improved Private Messaging,” the disclosure of which is incorporated herein by reference in its entirety.

This application is related to a U.S. patent application having the attorney docket number CRIP-003/00US 324720-2003, filed Oct. 13, 2015, entitled “Methods and Apparatus for Database Access Controls to Provide Privileged Access to Private Messages to Protect Data from Unauthorized Disclosure,” the disclosure of which is incorporated herein by reference in its entirety.

### BACKGROUND

Some embodiments described herein relate to sending and/or receiving messages containing private information with partially obscured content. Partial obscuration of content can prevent or impede complete messages from being captured and/or replicated. In this way, information security can be enhanced such that unauthorized use of data associated with, for example, privacy violations, can be prevented or impeded.

The development of email, short message service (SMS) messages, multimedia messaging service (MMS) messages, and other similar modes of communication are ingrained in modern life. Such rapid communication modes are used to communicate everything from the trivial to the mission critical. These known communication modes, however, are built on the premise that the sender trusts the recipient. For example, using known communication methods, it is typically easy to copy, forward, and/or save messages in their entirety. Furthermore, known communication methods typically transmit message content and sender information to the recipient, such that the recipient can identify the sender. Even services that offer disappearing messages are vulnerable to the recipient capturing a screenshot or photographing the recipient, which, if revealed, will tie the sender to the content of the message.

In some situations, however, security concerns may dictate that the recipient should not be trusted to maintain the confidentiality of sensitive information and/or the sender may not wish to be linked to the content of the message. A need therefore exists for methods and apparatus for communicating private messages with partially obscured content to prevent unauthorized use of data inclu.

### BRIEF DESCRIPTION OF THE FIGURES

FIG. 1 is a schematic illustration of a system for communicating private messages with partially obscured content, according to an embodiment.

FIG. 2 is a signal diagram illustrating an example of communicating private messages with partially obscured content, according to an embodiment.

FIGS. 3A and 3B are screenshots of instances of an application operable to compose messages, send messages, receive messages, and/or set permissions for messages, according to an embodiment.

FIGS. 3C and 3D are screenshots of instances of an application operable to receive and/or present message content and/or an identity of a sender, and/or obscure message content and/or identity of a sender, according to an embodiment.

FIGS. 4A and 4B are screenshots of instances of an application operable to compose messages for a group, receive group messages, and/or set permissions for group messages, according to an embodiment.

### SUMMARY

Some embodiments described herein relate to receiving a content portion of a message during a first time period. The content portion of the message can be presented during the first time period without a sender identifier. During a second time period after and mutually exclusive from the first time period, a user can request the sender identifier. The sender identifier can be presented during the second time period without presenting the content portion of the message. In this way, the sender identifier and the content portion of the message may not be presented simultaneously.

### DETAILED DESCRIPTION

Some embodiments described herein relate to a method that includes receiving a signal from a sender associated with a content portion of a message. The server can define an identifier associated with the content portion of the message and/or the sender of the message. The identifier can be sent to a recipient device, such that the recipient device can request the content portion of the message and/or the identity of the sender from the server. The server can establish a communication channel with the recipient device in response to the recipient device requesting the content portion of the message and/or the identity of the sender. The communication channel can provide the recipient device access to one of the content portion of the message or the identity of the sender, but not both simultaneously. The communication channel can be configured such that when the server does not provide access to the content portion of the message, the recipient device cannot present the content portion of the message. Similarly, the communication channel can be configured such that when the server does not provide access to the identity of the sender, the recipient device cannot present the identity of the sender.

Some embodiments described herein relate to a method that includes receiving a signal from a sender device associated with a message for a recipient, the message can include a content portion and a sender identifier associated with the sender device. The content portion can be stored in memory. A signal including an instruction configured to provide access to the content portion of the message can be sent to a recipient device associated with the recipient. In response, a request for the content portion of the message can be received from the recipient device. A signal including the content portion of the message can then be sent to the recipient device such that the recipient device presents the content portion of the message without the sender identifier. The method can also include receiving a request for the sender identifier from the recipient device. In response to receiving the request for the sender identifier, a signal including the sender identifier can be sent to the recipient device such that the recipient device presents the sender identifier without simultaneously presenting the content portion of the message.

Some embodiments described herein relate to receiving a content portion of a message during a first time period. The content portion of the message can be presented during the first time period without a sender identifier. During a second time period after the first time period, a user can request the sender identifier. The sender identifier can be presented during the second time period without presenting the content portion of the message. In this way, the sender identifier and the content portion of the message may not be presented simultaneously.

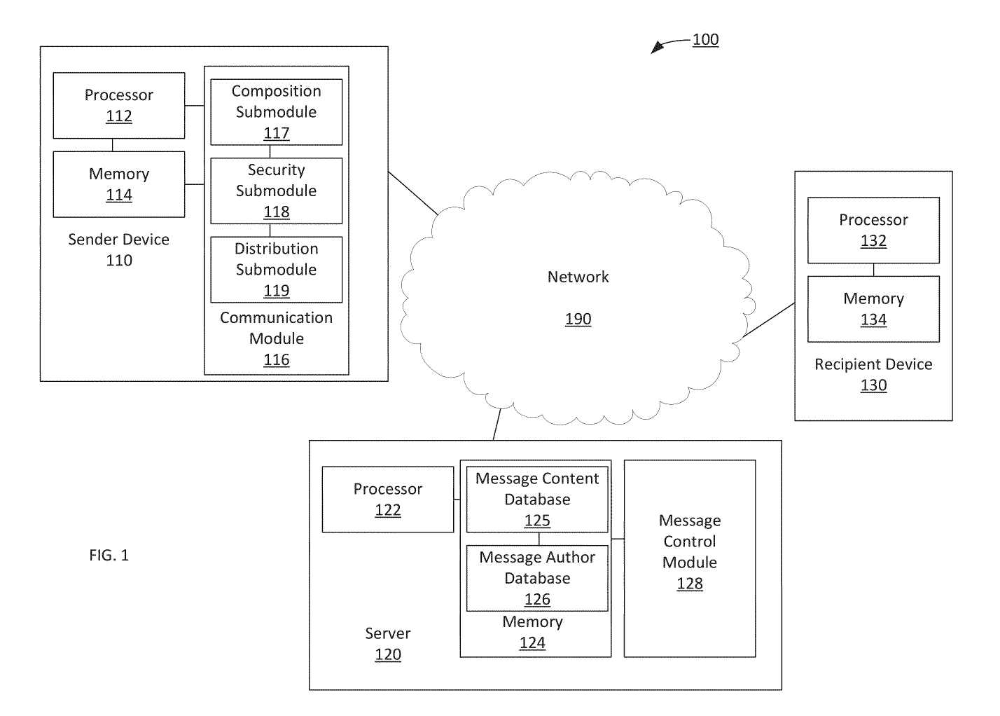

FIG. 1 is a schematic illustration of a system 100 for communicating private messages with partially obscured content, according to an embodiment. The system 100 includes a sender device 110, a server 120, and a recipient device 130 communicatively coupled via a network 190. The network 190 can be, for example, the Internet, an intranet, a local area network (LAN), a wide area network (WAN), a virtual network, a telecommunications network, any other suitable communication system and/or combination of such networks. The network 190 can be implemented as a wired and/or wireless network.

The sender device 110 can be a computing entity, such as a smartphone, a laptop computer, a desktop computer, etc. The sender device 110 includes a processor 112, a memory 114, and a communication module 116. The processor 112 can be, for example, a general purpose processor, a Field Programmable Gate Array (FPGA), an Application Specific Integrated Circuit (ASIC), a Digital Signal Processor (DSP), and/or the like. The processor 112 can be configured to retrieve data from and/or write data to memory, e.g., the memory 114, which can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth.

The communication module 116 can be hardware and/or software (stored in the memory 114 and/or executing on the processor 112) operable to enable a user of the sender device 110 to compose, send, and/or control the distribution of messages. The communication module 116 includes a composition submodule 117, a security submodule 118, and a distribution submodule 119.

The composition submodule 117 can be any suitable hardware and/or software (e.g., stored in memory and/or executing on a processor) operable to enable the user of the sender device 110 to compose a message. For example, the composition submodule 117 can be operable to receive signals from an input device or component (not shown) such as a hardware and/or virtual keyboard, touchscreen, mouse, microphone, etc. Furthermore, the composition submodule 117 can be operable to retrieve data, such as pictures, videos, stored text, etc. from local and/or remote memory for inclusion in the message. The composition submodule 117 can be operable to construct, format, locally store (e.g., in memory 114), and/or otherwise translate signals received from the input device into a form capable of transmission to other computing entities such as the server 120 and/or the recipient device 130. The composition submodule 117 can be communicatively coupled to the security submodule 118.

The security submodule 118 can be any suitable hardware and/or software (e.g., stored in memory and/or executing on a processor) operable to apply cryptographic, permission-based, and/or any other suitable access controls to the message and/or information identifying the sender device 110. For example, the security submodule 118 can encrypt the message by applying a public key associated with the server 120, a public key associated with an intended recipient (e.g., the user of the recipient device 130), and/or any other suitable technique. For example, the security submodule 118 can be operable to encrypt the message a first time using a public key associated with an intended recipient and then, after the message has been encrypted once, encrypt the message a second time using a public key associated with the server 120. In this way, retrieving the contents of the message may entail first decrypting using a private key associated with the server 120 and subsequently using a private key associated with the intended recipient to decrypt the message a second time. Such serial encryption can prevent users associated with the server 120 from decrypting the contents of the message while simultaneously preventing out-of-band exchange of the contents of the message, such that the user of the sender device 110 can restrict the exchange of the contents of the message to a communications channel including the server 120.

In some instances, the security submodule 118 can be operably coupled to a network module (not shown) such as a network interface controller (NIC), Bluetooth® module, and/or any other suitable hardware and/or software (stored in memory and/or executing on a processor) operable to communicatively couple the sender device 110 to the network 190 and/or any other suitable computing entity. The security submodule 118 can be operable to cause the network module to send information associated with the contents of a message (e.g., composed and/or assembled by the composition module 117), information associated with the sender device 110, and/or information associated with the user of the sender device 110. For example, the security submodule 118 can be operable to cause the network module to transmit information associated with the contents of the message in one data packet (or one set of data packets) and information associated with the sender device 110 and/or the user of the sender device 110, such as real name, username, pseudonym, return address, a public key associated with the sender device 110, internet protocol (IP) address of the sender device 110, etc. in a second, different, data packet (or second set of data packets). In such an instance, no single data packet (or single set of data packets) may include both content information and information identifying the sender. Thus, interception of one packet (or one set of data packets) may include insufficient data to identify both the contents of a message and the sender of the message.

The security submodule 118 can be communicatively coupled to the distribution module 119. The distribution submodule 119 can be operable to coordinate with the server 120 to control the distribution of messages. The distribution submodule 119 can be operable to cause messages intended for recipient device 130 to be routed to the server 120 such that the recipient device 130 can retrieve message content and/or sender information from the server 120. For example, the distribution submodule 119 can be operable to issue commands, make calls to, and/or otherwise interact with an application programming interface (API) implemented on the server 120. The distribution submodule 119 can be operable to indicate the distribution of the message (e.g., specify intended recipient(s) such as the user of the recipient device 130); set conditions for forwarding, copying, capturing a screenshot of the message, etc.; specify a blacklist of recipients who do not have permission to access the message; specify anonymity conditions, such as indicating that the recipient should receive the message without the sender being identified; indicating the message be restricted from being displayed simultaneously with the sender information; indicating that the message may be displayed with the sender information; set an expiration time for messages; request delivery notifications; recall previously sent messages; and/or so forth.

The server 120 can be any suitable computing entity, such as a webserver. The server 120 includes a processor 122 and a memory 124, which can be structurally similar to the processor 112 and/or the memory 114, respectively. The server 120 further includes a message control module 128.

In some instances, the server 120 can be operable to receive a message including message content and an identity of the sender from the sender device 110 via the network. The message content and the identity of the sender can be received in a single transmission or data packet or in multiple transmissions or data packets. For example, the server 120 can be operable to receive one data packet (or set of data packets) containing the message content (optionally without any information identifying the sender device 110 and/or the user of the sender device 110), and a second data packet (or set of data packets) containing information identifying the sender device 110 and/or the user of the sender device 110 (optionally without any information associated with message content). Alternatively, the server 120 can be operable to identify the sender device 110 using information embedded within a data packet containing the content of the message, such as an IP address. The server 120 can be operable to store message contents in a message received from the sender device 110 content database 125. The server 120 can further be operable to store information identifying the sender (e.g., the user of the sender device 110) received from the sender device 110 in a separate (physical and/or logical) message author database 126. The server 120 can further define and/or store a link between message content and the identity of the sender of the message. In other instances, message contents and information identifying a sender can be stored in a single database.

The server 120 can be operable to provide access to message content and/or sender identity to a recipient (e.g., a user of the recipient device 130). In this way, the server 120 can act as an intermediary between the sender device 110 and the recipient device 130 such that the recipient device 130 does not receive data directly from the sender device 110. Such an intermediary can inhibit the user of the recipient device 130 from identifying the sender device 110 (e.g., via IP address). Furthermore, as discussed in further detail herein, the server 120 can verify that the recipient device 130 is executing an application (on a processor 132) configured to receive the message and enforce access controls on message, such as, no forwarding, no saving, no screenshotting, etc. The server 120 can also be operable to “stream” the message content and/or the identity of the sender, for example, by providing access to the message content and/or the identity of the sender using an iframe or similar suitable technique. Such an iframe can be automatically refreshed, for example, every 30 seconds, every 10 seconds, every second, etc. An automatic refresh of an iframe (or similar streaming presentation) every 3 seconds or less is referred to herein as “substantially continuous.” By substantially continuously refreshing the message content and/or the identity of the sender, the server 120 can be operable to revoke access to the message content and/or the identity of the sender, for example, by refreshing to a blank screen or filler content. Alternatively, an application (executing on the processor 132 of the recipient device 130) can be operable to periodically and/or substantially continuously poll the server 120 for updated instructions regarding the message content and/or sender identifier. For example, the recipient device 130 can seek continuing permission from the server to present the message content and/or identity of the sender.

The recipient device 130 can be any suitable computing entity, such as a desktop computer, a laptop computer, a cellular telephone, etc. The recipient device 130 includes the processor 132 and a memory 134, which can be structurally and/or functionally similar to the processor 112 and/or the memory 114, respectively. The recipient device 130 can be operable to receive a notification that the server 120 has received a message intended for the user of the recipient device 130 and to receive the contents of the message and/or an indication of the sender of the message. Similarly stated, the server 120 can send an identifier associated with the message content and/or sender identity to the recipient device 130 such that the recipient 130 can send a request for the message content and/or identity of the sender to the server 120.

In some instances, the recipient device 130 (optionally in conjunction with the server 120) can be configured such that the content of a message and an identity of the sender are not displayed simultaneously. For example, the recipient device 130 (optionally in conjunction with the server 120 and/or at the request of the sender device 110) can be configured such that the content of the message and the identity of the sender are only displayed during mutually exclusive time periods. In some instances, the contents of a message and the identity of the sender of the message can be less sensitive when displayed separately, than when displayed simultaneously. Similarly stated, a message or picture of a message (e.g., captured via a screenshot) containing attribution to the sender may be more sensitive than message contents that cannot be positively linked to the sender. For example, if a message is captured (e.g., saved or captured via a screenshot functionality) the sender may retain plausible deniability that the sender was not the author of the message if the sender's identity is not simultaneously presented with the message content.

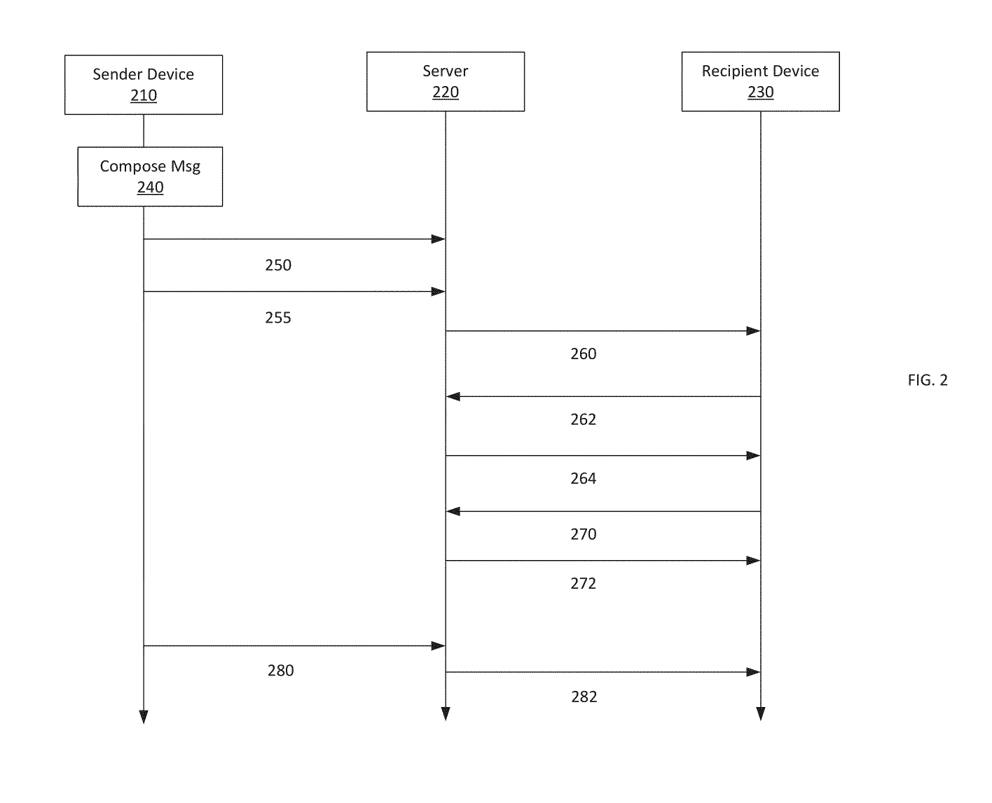

FIG. 2 is a signal diagram illustrating an example of communicating private messages with partially obscured content. The signal diagram depicts a sender device 210, a sever 220, and a recipient device 230, each of which can be structurally and/or functionally similar to the sender device 110, the server 120, and the recipient device 130, respectively.

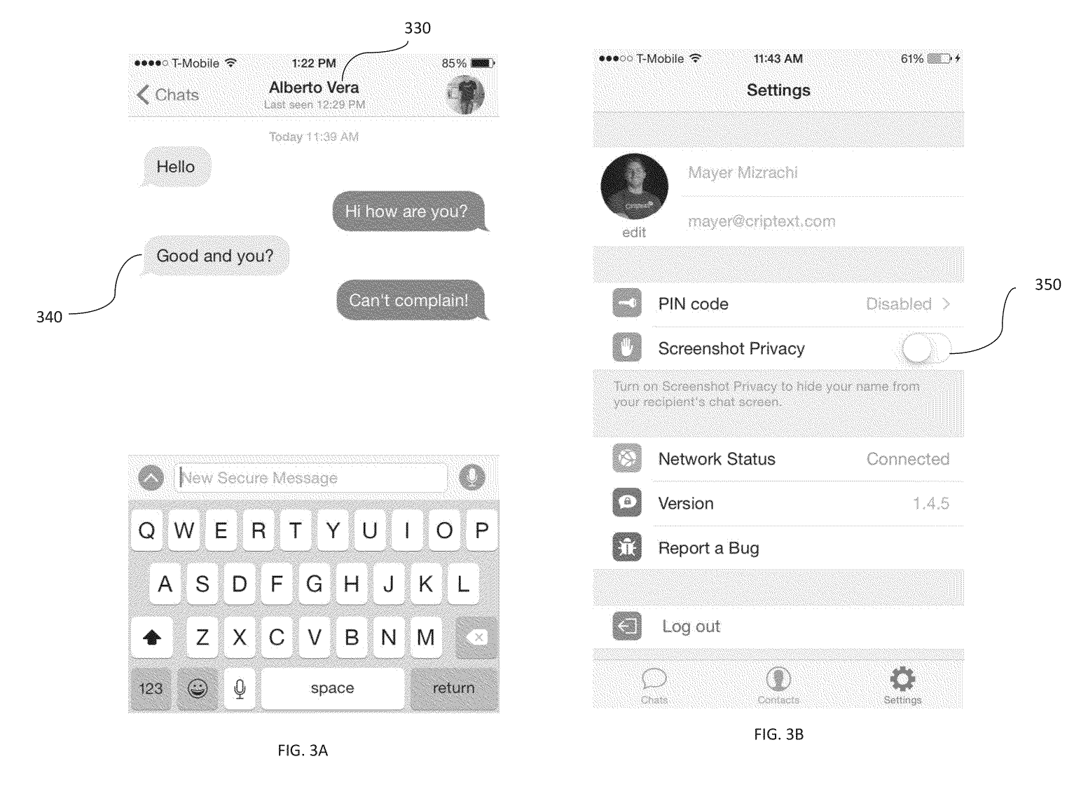

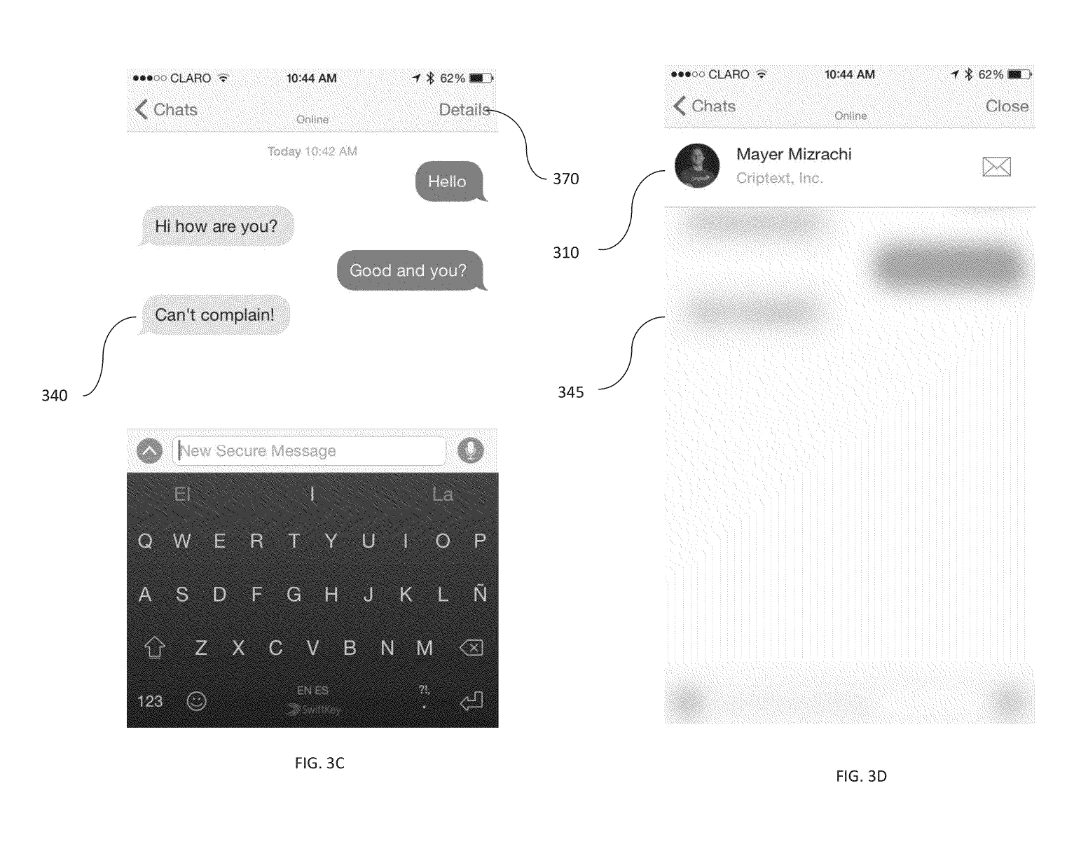

At 240, a message can be composed at the sender device 210. For example, a user of the sender device 210 can type an email, MMS message, select a file (stored in a memory) to be sent, etc. FIG. 3A is a screenshot of an application operable to compose a message 340 at 240, according to an embodiment. The sender device 210 can send signal 250 representing the contents of the message 340 to the server 220. Optionally, the sender device 210 can specify the intended recipient(s), such as the user 330 of the recipient device 230. Signal 250 can further include permissions for the message. For example, signal 250 can include an instruction that the message is not intended to be forwarded, saved, distributed to identified (e.g., blacklisted) recipients, distributed outside a (whitelisted) group of individuals such as recipients within an organization, etc. FIG. 3B is a screenshot of the application of FIG. 3A showing a setting for setting a permission for the message 340, according to an embodiment. FIG. 3B depicts a toggle 350 operable to set “screenshot privacy” for the message 340 and/or any other messages sent to the recipient 330. The server 220 can receive and store the contents of the message and/or any instructions associated with permissions for the message. In some instances, signal 250 can be devoid of an indication of the identity of the user of the sender device 210. For example, signal 250 may not include any information personally identifying the user of the sender device 210.

At 255, the sender device 210 can send an indication of the user of the sender device's 210 identity, such as a real name, user name, etc. In some instances, signal 255 can include an identifier (e.g., serial number) associated with the contents of the message and/or a hash of the contents of the message such that the server 220 can be operable to associate the indication of the sender's identity sent at 255 with the contents of the message sent at 250. In this way, no single signal includes both the contents of the message and the indication of the sender's identity. Thus, if one of signal 250 or signal 255 were intercepted, such an intercepted signal would be insufficient to reveal both the contents of the message and the identity of the sender. In other embodiments, signal 250 may only include the contents of the message and the server 220 may be able to infer the identity of the sender via an IP address associated with signal 250 or may be able to associate a real identity of the sender (e.g., real name) with a pseudonym (such as a user name) included in signal 250.

The server can send signal 260 notifying the recipient device 230 that a message is available. Signal 260 may include an indication associated with the message (e.g., an indication defined by the server 220). The indication associated with the message can be operable to cause the recipient device 230 to retrieve the message and/or identity of the sender. Alternatively, the indication associated with the message can be operable to cause the recipient device 230 to display a prompt or graphical element that can be selected by the user of the recipient device 230 to cause the recipient device 230 to retrieve the message and/or identity of the sender. For example, the indication can be a web address uniquely associated with the message. Signal 260 may be devoid of information associated with the user of the user device 210 and/or may be devoid of personally identifying information.

In response, to receiving signal 260, the recipient device 230 can send signal 262 representing a request for the message. The server 220 can verify that the recipient device 230 is an intended recipient of the message and/or can verify that the recipient device 230 is executing (on a processor) an application operable to enforce access controls associated with the message. For example, the server 220 can verify that the recipient device 230 is executing (on a processor) a messaging application associated with the server 220. Upon verifying the recipient device 230, the server 220 and can send signal 264 representing the content of message 340 (e.g., without transmitting the identity of the sender) to the recipient device 230. Upon receiving signal 264, the recipient device 230 can be operable to present the contents of the message to the user of the recipient device 230.

FIG. 3C is a screenshot of an application operable to receive and display message 340, according to an embodiment. As shown in FIG. 3C, the identity of the sender is not displayed. The identity of the sender may not be displayed based on the user of the sender device 210 setting the “screenshot privacy” toggle 350. The application shown in FIG. 3A and the application shown in FIG. 3C may be different instances of the same application. Similarly stated, the sender device 210 and the recipient device 230 may be executing (on processors) different instances of a common messaging application associated with server 220 such that each of the sender device 210 and the recipient device can be used to compose, send, and receive messages and enforce access controls and/or privacy settings.

In some embodiments, upon receiving signal 264, the recipient device 230 may not have received, and thus may not be operable to present the identity of the sender. In some instances, the recipient device 230 may be operable to present the content of the message via an iframe or other automatically and/or substantially continuously refreshing means. Similarly stated, signal 264 can represent a communication channel for transmitting the content of the message such that the server 220 can be operable cause the recipient device 230 to update, modify, and/or replace the contents of the message with other information, a blank screen, etc. Furthermore, the server 220 and the recipient device 230 can be collectively configured such that if the communication channel represented by signal 264 is closed (e.g., if the connection is terminated, lost, an update is not received within a predetermined length of time, the iframe is delinked from a database entry storing the contents of the message, etc.), the recipient device 230 can cease presenting the contents of the message. Similarly stated, the server 220 and the recipient device 230 can be collectively configured such that if an instruction configured to provide access to the content of the message is disabled, the recipient device's 230 access to the content portion of the message can be revoked.

In some embodiments, the server 220 can be operable to verify that the recipient device 230 is configured to respect access controls set by the sender device 210 and/or enforced by the server 220 before sending signal 264. For example, signal 262 can include an indication, such as a cryptographic key or signature, indicating that the contents of the message are being requested via a computer program or application (stored in memory and executing on a processor) that is configured to respect access controls. For example, if saving and/or capturing screenshots of the contents of the message are not permitted, the application may disable such functionality at the recipient device 230 while the contents of the message are being presented.

The recipient device 230 can send signal 270 to request the identity of the sender. For example, the recipient device 230 can be operable to execute a program (stored in memory and executing on a processor) that includes a prompt or graphical element that causes the recipient device 230 to send signal 270 in response to the prompt being triggered. For example, as shown in FIG. 3C, signal 270 can be sent in response the user of the recipient device 230 selecting the “details” prompt 370. In other instances, signal 270 can be sent in response to any suitable input, such as a keyboard input. In response to sending signal 270, the recipient device 230 can cease presenting or obscure the content portion of the message, for example, based on the server 220 receiving signal 270 and closing the communication channel represented by signal 264 and/or based on the program running on the recipient device 230 ceasing to present or obscuring the contents of the message when the recipient device 230 sends signal 270. FIG. 3D is a screenshot of the application of FIG. 3C showing the content portion of message 340 not being presented and/or being obscured 345. In response to receiving signal 270, the server 220 can send signal 272, which can include a representation of the identity of the sender and/or the sender device 210. As shown in FIG. 3D, the identity of the sender 310 can be displayed by the recipient device 230 in response to receiving signal 272. In some instances, the server 220 can be operable to verify that the recipient device 230 has ceased presenting the message contents before sending signal 272. For example, the server 220 can receive confirmation from the recipient device 230 that the contents of the message are not displayed, are obscured, and/or have been deleted before sending signal 272. Similar to signal 264, signal 272 can represent a communication channel such that the server can be operable to cause the recipient device 230 to update, modify, and/or replace the identity of the sender and/or the sender device 210. Furthermore, the recipient device 230 can be configured such that the identity of the sender and/or the sender device 210 is no longer presented when the communication channel represented by signal 272 is closed.

At 280, the sender device 210 can send a signal to the server device 220 requesting that the message contents and/or the identity of the sender be recalled. In response, the server 220 can send signal 282 to the recipient device 230 such that the recipient device 230 ceases to present and/or deletes the message contents and/or the identity of the sender and/or the sender device 210. For example, signal 282 can represent closing the communication channel represented by signal 264, closing the communication channel represented by signal 272, updating an iframe that previously contained the message content and/or sender identity with blank and/or filler content, and/or otherwise cause the message content and/or sender identity to be recalled.

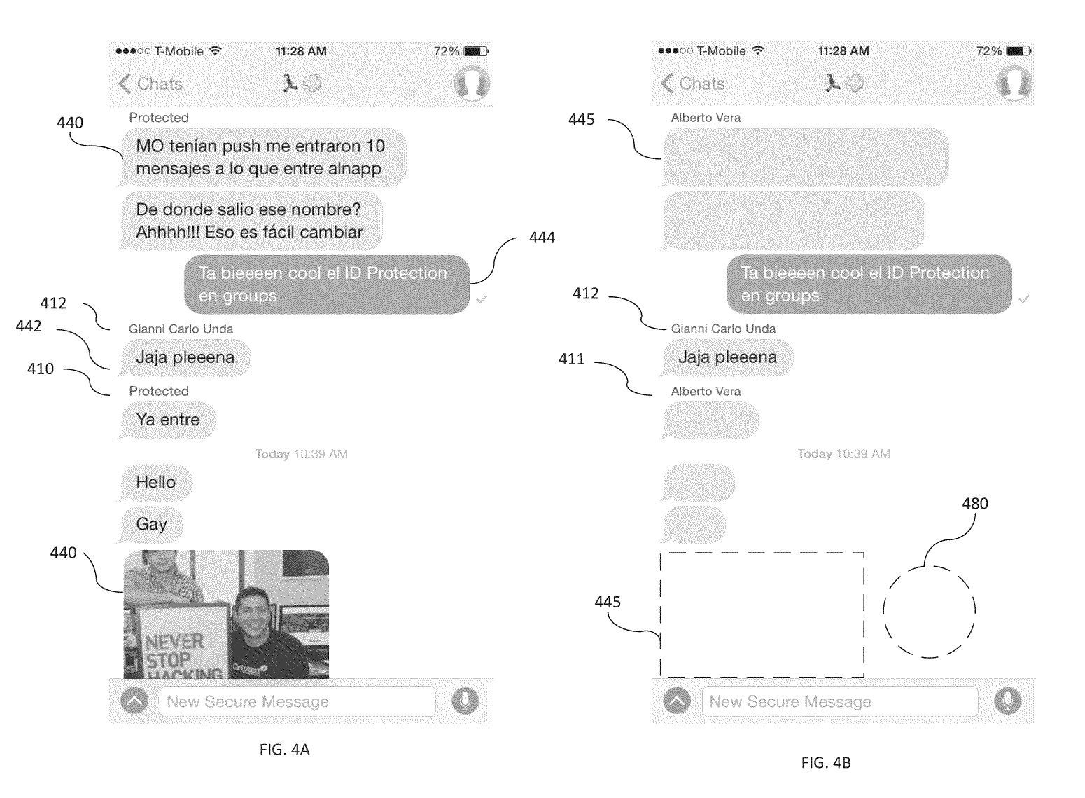

FIGS. 4A and 4B are screenshots of instances of an application operable to compose messages for a group, receive group messages, and/or set permissions for group messages, according to an embodiment. The application can be executed (on a processor) of a recipient device, which can be structurally and/or functionally similar to the recipient device 130. The application depicted in FIGS. 4A and 4B can be similar to the application depicted in FIGS. 3A-3D. Although not shown in FIG. 4A or 4B, a similar application or another instance of the application shown in FIGS. 3A-3D and/or 4A and 4B can be executed (on a processor) of sender devices, which can be structurally and/or functionally similar to the sender device 110.

As shown in FIG. 4A, the application displays messages 440 from a first sender 410, messages 442 from a second sender 412, and a message 444 from the recipient 430 to the first sender 410 and the second sender 412. As shown in FIG. 4A, the content of messages 440 and are presented, but the identity of the first sender 410 is protected and not presented. For example, the content of the messages 440 (which can include text, pictures, video, audio, etc.) can be presented without the identity of the first sender 410 in response to the first sender 410 setting a permission for the messages 440 that indicates the content of the messages 440 and the identity of the sender are not to be simultaneously presented. In contrast, the identity of the second sender 412 and the content of message 442 are presented simultaneously. For example, the second sender 412 may not have set a privacy permission and/or the application used by the second sender 412 (executing on a processor) may not be operable to set privacy permissions.

As shown in FIG. 4B, the identity of the first sender 411 is presented while the content of messages 445 is not presented. As described in further detail herein, the user of the recipient device can toggle between presenting the content of the messages 440 as shown in FIG. 4A and the identity of the first sender 411, as shown in FIG. 4B. For example, the application can be operable to toggle between displaying the content of the messages 440 and the identity of the first sender 411 when a user input is supplied. For example, as indicated at 480, the identity of the first sender 411 can be presented while the user of recipient device touches (and optionally continuously touches) a touch screen of the recipient device. In some instances, an indication of the user of the recipient device supplying the user input can be sent to a server, for example as described above with reference to signal 270 such that the server sends the recipient device the identity of the first sender 411.

While various embodiments have been described above, it should be understood that they have been presented by way of example only, and not limitation. Although various embodiments have been described as having particular features and/or combinations of components, other embodiments are possible having a combination of any features and/or components from any of embodiments where appropriate as well as additional features and/or components. For example, some embodiments describe a communication channel such that message content and/or sender identity can be substantially continuously refreshed. It should be understood that the sender can set an expiration timer for the message content and/or the sender identity such that the communication channel is closed and/or the message content and/or sender identity are otherwise caused to cease to be presented upon the expiration of the timer. U.S. Patent Application Pub. No. 2015/0096042 entitled “Method and Apparatus for Improved Private Messaging,” the disclosure of which is hereby incorporated by reference in its entirety, includes further disclosure of expiring messages and similar technique that may be used in conjunction with methods and apparatus described herein.

As another example, although certain methods, events and/or signals are described as occurring in a particular order, it should be understood that such methods, events, and/or signals can occur in any order, unless the description clearly indicates otherwise. For example, in some instances, signals associated with message content are described as being sent before signal associated with sender identity. It should be understood that signals associated with sender identity could be sent before signals associated with message content. As another example with reference to FIG. 2, signal 280, requesting message content and/or sender identity be recalled, is described as occurring after signals 264, representing the message content, and signal 272, representing sender identity, are sent. It should be understood that signal 280, requesting message content and/or sender identity be recalled, can be sent at any suitable time. In the event signal 280 is sent before signals associated message content and/or sender identity are sent to the recipient device 230, the server 220 can be configured to not send such signals (e.g., 264, 272) in response to receiving signal 280.

As another example, some embodiments describe sending a signal representing contents of a message before describing sending a signal representing the identity of the sender and/or sender device. It should be understood that message contents and sender and/or sender device identity can be sent (and/or presented by a recipient device) in any order and/or simultaneously. Furthermore, it should be understood that a user of a recipient device can toggle between sender and/or sender device identity and message contents. For example, the recipient device can be operable to present a prompt or graphical element with message content that, when selected, can cause the recipient device (in conjunction with a server) to cease presenting message content and toggle to information identifying the sender and/or sender device. Similarly, the recipient device can be operable to present a prompt or graphical element when presenting information associated with the sender's identity and/or the identity of the sender device that, when selected, can cause the recipient device (independently and/or in conjunction with the server) to cease presenting information associated with the sender's identity and/or the identity of the sender device and toggle to message content.

As another example, some embodiments described herein relate to the user of a sender device setting permissions for a message. It should be understood that such permissions can be enforced and/or violations of such permissions can be reported by recipient device(s) and/or servers. For example, in an instance where the user of the sender device prohibits screenshots of message content and/or sender identity from being taken, an application configured to retrieve the message content executing on a processor of a recipient device may disable screenshot functionality. In addition or alternatively, such an application may report when the user of the recipient device attempts to capture a screenshot.

Furthermore, some embodiments describe various components of computing entities, such as processors and memories. It should be understood that computing entities may include additional elements, such as network adaptors, input/output modules, and or any other suitable hardware and/or software (stored in memory and/or executing on the processor) to perform any of functions described herein and/or any other suitable function.

Where signal diagrams are described, it should be understood that any device(s) can engage in a method including sending and/or receiving described communications. Where methods are described, it should be understood that the methods can be stored as code in a non-transitory computer readable medium (e.g., a memory). Such code can be configured to cause a processor to execute the method and/or cause the processor to bring about an event. Similarly stated, where methods are described, it should be understood that the methods can be implemented by a computer. Some embodiments described herein relate to computer-readable medium. A computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes including for example some or all of the processes and methods described above. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as ASICs, PLDs, ROM and RAM devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

What is claimed is:

1. A method, comprising:
receiving, at a server, a signal from a sender including a content portion of a message;
defining an identifier associated with the at least one of the content portion of the message or the sender;
sending the identifier to a recipient device;
receiving, in response to sending the identifier to the recipient device, a request from the recipient device for the at least one of the content portion of the message or an identity of the sender; and
establishing a communication channel with a recipient device in response to the request such that the server provides access to one of the content portion of the message or the identity of the sender, but not both the content portion of the message and the identity of the sender simultaneously, the communication channel configured such that (1) when the server does not provide access to the content portion of the message, the recipient device cannot present the content portion of the message and (2) when the server does not provide access to the identity of the sender, the recipient device cannot present the identity of the sender.

2. The method of claim 1, wherein the communication channel is configured such that when the communication channel is closed, the recipient device ceases to present the at least one of the content portion of the message or the identity of the sender.

3. The method of claim 1, wherein the communication channel is configured such that the recipient device can toggle between being provided access to the content portion of the message or being provided access to the identity of the sender.

4. The method of claim 1, wherein the signal from the sender is devoid of the identity of the sender, and the identifier is devoid of personally identifiable information.

5. The method of claim 1, wherein the content portion of the message and the identity of the sender are sent in separate packets via the communication channel.

6. The method of claim 1, further comprising:
receiving a signal from the recipient device in response to a user of the recipient device attempting to store a copy of the content portion of the message; and
notifying the sender that the user of the recipient device attempted to store a copy of the content portion of the message.

7. The method of claim 1, wherein the signal received from the sender is associated with a multimedia messaging service.

8. A non-transitory processor readable medium storing code representing instructions configured to be executed by a processor, the code comprising code configured to cause the processor to:
receive a signal from a sender device associated with a message intended for a recipient, the message including a content portion and a sender identifier associated with the sender device;
store the content portion of the message in a memory;
send a first signal to a recipient device associated with the recipient, the first signal including an instruction configured to provide access to the content portion of the message;
receive, from the recipient device, a request for the content portion of the message;
send a second signal to the recipient device in response to the request for the content portion of the message such that the recipient device presents the content portion of the message without the sender identifier;
receive, from the recipient device, a request for the sender identifier; and
send a third signal to the recipient device in response to receiving the request for the sender identifier such that the recipient device presents the sender identifier without simultaneously presenting the content portion of the message.

9. The non-transitory processor readable medium of claim 8, further comprising code to cause the processor to:
disable the instruction configured to provide access to the content portion of the message such that the recipient device's access to the content portion of the message is revoked.

10. The non-transitory processor readable medium of claim 9, wherein the code to cause the processor to disable the instruction is configured to disable the instruction such that the recipient device ceases to present the content portion of the message.

11. The non-transitory processor readable medium of claim 9, further comprising code to cause the processor to:
receive a signal from the sender device to disable the instruction, the signal to disable the instruction received after receiving the signal requesting the content portion of the message, the instruction configured to provide access to the content portion of the message disabled in response to receiving the signal to disable the instruction.

12. The non-transitory processor readable medium of claim 8, wherein:
the signal associated with the message includes at least a signal associated with the content portion and a signal associated with the sender identifier; and
the code to cause the processor to store the content portion of the message in the memory includes code to store the content portion of the message without the sender identifier.

13. The non-transitory processor readable medium of claim 8, further comprising code to cause the processor to:
receive, from the recipient device, a request for the content portion of the message after receiving the request for the sender identification; and
send a fourth signal to the recipient device such that the recipient device to toggles between presenting one of the content portion of the message or the sender identifier in response to the most recent of (1) the request for the content portion of the message or (2) the request for the sender identifier.

14. The non-transitory processor readable medium of claim 8, wherein the instruction configured to provide access to the content portion of the message is an iframe linked to the content portion of the message.

15. The non-transitory processor readable medium of claim 14, the code further comprising code to cause the processor to:
delink the iframe and the content portion of the message such that the recipient device refreshes the iframe and ceases to present the content portion of the message.

16. A non-transitory processor readable medium storing code representing instructions configured to be executed by a processor, the code comprising code to cause the processor to:
receive, from a server and during a first time period, a content portion of a message intended for a recipient;
present, during the first time period, the content portion of the message without a sender identifier;
receive, from the recipient during the first time period, a request for the sender identifier; and
present the sender identifier during a second time period after and mutually exclusive of the first time period, the content portion of the message not presented during the second time period.

17. The non-transitory processor readable medium of claim 16, further comprising code to cause the processor to:
send a signal to the server including a verification that the content portion of the message is not presented response to receiving the request for the sender identifier; and
receive a signal from the server including the sender identifier in response to sending the verification that the content portion of the message is not presented.

18. The non-transitory processor readable medium of claim 16, wherein the code to cause the processor to present the content portion of the message includes code to cause the processor to retrieve the content portion of the message from the server and substantially continuously refresh the presentation of the content portion of the message.

19. The non-transitory processor readable medium of claim 18, wherein the substantially continuously refresh of the presentation of the content portion of the message is configured to cause the processor to cease presenting the content portion of the message when the server removes the availability of the content portion of the message.

20. The non-transitory processor readable medium of claim 16 further comprising code to cause the processor to send a signal to the server in response to the recipient attempting to store a copy of the content portion of the message.
